(19) United States
(12) Patent Application Publication
(10) Pub. No.: US 2010/0134536 A1
(43) Pub. Date: Jun. 3, 2010

(54) LIQUID CRYSTAL DISPLAY DEVICE AND METHOD FOR COMPENSATING IMAGE THEREOF

(75) Inventors: WEI GUO, Shenzhen (CN); SHUN-MING HUANG, Shenzhen (CN)

Correspondence Address: PCE INDUSTRY, INC.;ATT. Steven Reiss, 288 SOUTH MAYO AVENUE, CITY OF INDUSTRY, CA, 91789, US

(73) Assignees: INNOCOM TECHNOLOGY (SHENZHEN) CO., LTD., Shenzhen City (CN); INNOLUX DISPLAY CORP., Miao-Li County (TW)

(21) Appl. No.: 12/620,737

(22) Filed: Nov. 18, 2009

(30) Foreign Application Priority Data
Dec. 3, 2008 (CN) 200810305934.0

(51) Int. Cl. G09G 5/10; G09G 3/36

(52) U.S. Cl. 345/690; 345/89

(57) ABSTRACT

An exemplary liquid crystal display (LCD) device includes a liquid crystal pane and a gamma correction module. The liquid crystal panel includes a plurality of pixels including normal pixels and abnormal pixels. For a same gray scale, the normal pixels are driven by a first gray scale signal and the abnormal pixels are driven by a second gray scale signal, in order that the brightness of an image displayed by the normal pixels and the brightness of the image displayed by the abnormal pixels are substantially identical.

### BACKGROUND

1. Technical Field

The disclosure relates to display devices, and particularly to a liquid crystal display (LCD) device and method for compensating an image thereof.

2. Description of Related Art

LCD devices provide advantages such as small volume, light weight and low power consumption, and are applicable in a variety of electronic and communication devices including notebook computers, personal digital assistants (PDA), mobile phones and others.

However, during manufacture, abnormal pixels of the LCD devices are usually due to non-uniformity of an alignment film, or, one or even both of two glass substrates of the LCD device is or are not flat. When the abnormal pixels and normal pixels are both driven by a same gray scale voltage, an image displayed by the abnormal pixels may be brighter or dimmer than brightness or dimness of the normal pixels. Therefore, color differences can be observed between the image displayed by the abnormal pixels and the image displayed by the normal pixels, which greatly impact viewability of the LCD device, and display quality cannot be guaranteed.

What is needed, therefore, is an LCD device and a method which can overcome the described limitations.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the described embodiments. In the drawings, like reference numerals designate corresponding parts throughout various diagrams.

FIG. 1 is a block schematic diagram of one embodiment of an LCD device of the present disclosure.

FIG. 2 is a flowchart summarizing an exemplary method for compensating an image of an LCD device, such as, for example, that of FIG. 1.

FIG. 3 is a block diagram of one embodiment of a gamma correction module of the LCD device of FIG. 1.

### DETAILED DESCRIPTION

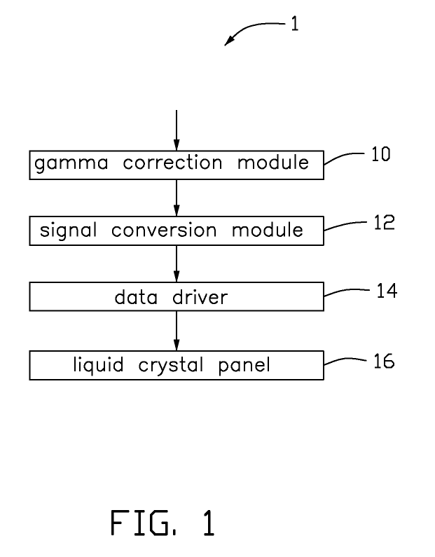

Referring to FIG. 1, one embodiment of an LCD device 1 includes a gamma correction module 10, a signal conversion module 12, a data driver 14 and a liquid crystal panel 16. The liquid crystal panel 16 includes a plurality of pixels, which include abnormal pixels and normal pixels. The abnormal pixels and the normal pixels can display images under control of different gray scales. The abnormal pixels may occur during manufacture or shipment, for example.

For simplicity, only one normal and one abnormal pixel are described in the following. However, it should be understood that a plurality of normal and abnormal pixels can be understood in a similar manner as will be described below.

An outer signal generator, such as a timing controller, generates a plurality of data signals and provides the data signals to the gamma correction module 10. The data signals include a first gray scale signal corresponding to a current gray scale of a pixel of the LCD device 1, an X axis synchronizing signal and a Y axis synchronizing signal of the first gray scale signal. Because the synchronizing signals are pulse wave signals, the number of pulses of the synchronizing signals defines X and Y coordinates of a functioning pixel. The gamma correction module 10 receives the data signals and determines that the first gray signal corresponds to a normal pixel or an abnormal pixel. When the first gray scale signal corresponds to the abnormal pixel, the gamma correction module 10 processes and regulates the first gray scale signal, and therefore outputs a corresponding second gray scale signal to the signal conversion module 12. The signal conversion module 12 converts the second gray scale signal and outputs a corresponding reduced swing differential signal (RSDS) to the data driver 14. The data driver 14 provides the RSDS to the abnormal pixel of the liquid crystal panel 16.

When the first gray signal corresponds to the normal pixel, the gamma correction module 10 continues outputting the first gray scale signal to the signal conversion module 12. The signal conversion module 12 converts the first gray scale signal and outputs another corresponding RSDS to the data driver 14. The data driver 14 provides the RSDS to the normal pixel of the liquid crystal panel 16.

When the LCD device 1 displays in the gray scale, the brightness of the image displayed by the abnormal pixel driven by the second gray scale signal is substantially identical with that of the normal pixel driven by the first gray scale.

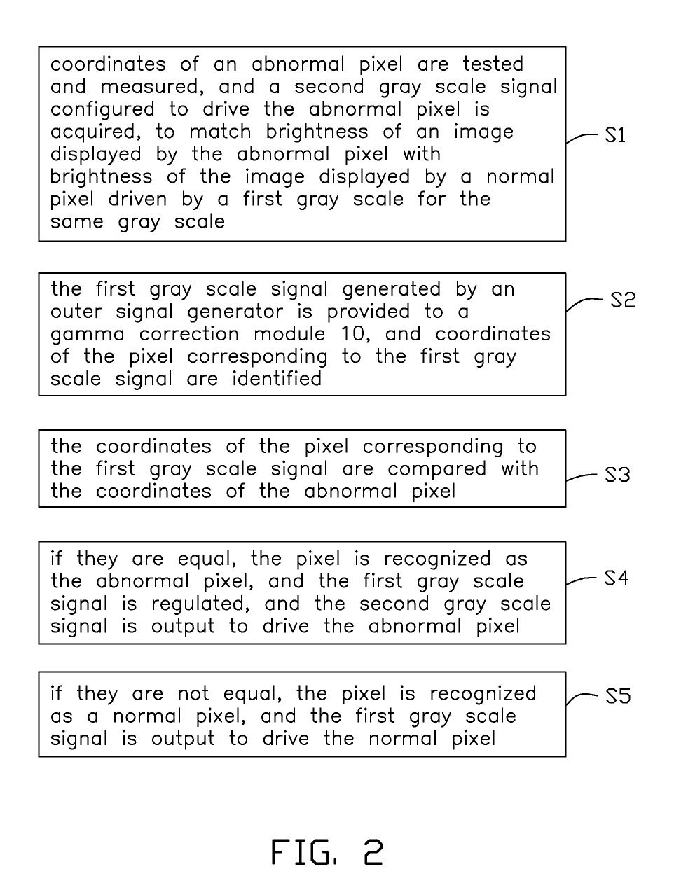

Referring to FIG. 2, an exemplary method for compensating an image of an LCD device 1 includes the following steps. In step S1, coordinates of an abnormal pixel are tested and measured, and a second gray scale signal configured to drive the abnormal pixel is acquired, to match brightness of an image displayed by the abnormal pixel with brightness of the image displayed by a normal pixel driven by a first gray scale for the same gray scale. In step S2, the first gray scale signal generated by an outer signal generator is provided to a gamma correction module 10, and coordinates of the pixel corresponding to the first gray scale signal are identified. In step S3, the coordinates of the pixel corresponding to the first gray scale signal are compared with the coordinates of the abnormal pixel. In step S4, if they are equal, the pixel is recognized as the abnormal pixel, and the first gray scale signal is regulated, and the second gray scale signal is output to drive the abnormal pixel. In step S5, if they are not equal, the pixel is recognized as a normal pixel, and the first gray scale signal is output to drive the normal pixel. A detailed description of an exemplary method for compensating the image of an LCD device is as follows:

In step S1, before the LCD device 1 normally works, a plurality of second gray scale signals configured to drive the abnormal pixel are tested under condition of displaying different gray scales, and stored in order that the brightness of the image displayed by the abnormal pixel is substantially identical with the brightness of the image displayed by the normal pixel driven by the first gray scale signal for the same gray scale. The coordinates of the abnormal pixel are measured using an optical apparatus. The coordinates include X and Y coordinates. The coordinates of the abnormal pixel are stored. Thus, the coordinates of the abnormal pixel, a plurality of different gray scales corresponding to the coordinates of the abnormal pixel, the first gray scale signals corresponding to the different gray scales, and the second gray scale signals corresponding to the different gray scales are stored in a lookup table. The first and the second gray scale signals corresponding to the same gray scale belong to one-to-one correspondence.

In step S2, when one of the pixels of the LCD device 1 displays one of the gray scales, a plurality of data signals are provided to the LCD device 1. The data signals include the first gray scale signal, a X axis synchronizing signal and a Y axis synchronizing signal of the first gray scale signal. Because the synchronizing signals are pulse wave signals, the coordinates of the functioning pixel are identified by calculating the number of pulses of the two synchronizing signals.

In step S3, the coordinates of the pixel corresponding to the first gray scale signal are compared with those of the abnormal pixel.

In step S4, if they are equal, the pixel is recognized as the abnormal pixel, and the first gray scale signal is regulated, and therefore a corresponding second gray scale signal is output to drive the abnormal pixel.

In step S5, if they are unequal, the pixel is recognized as the normal pixel, and the first gray scale signal is output to drive the normal pixel directly.

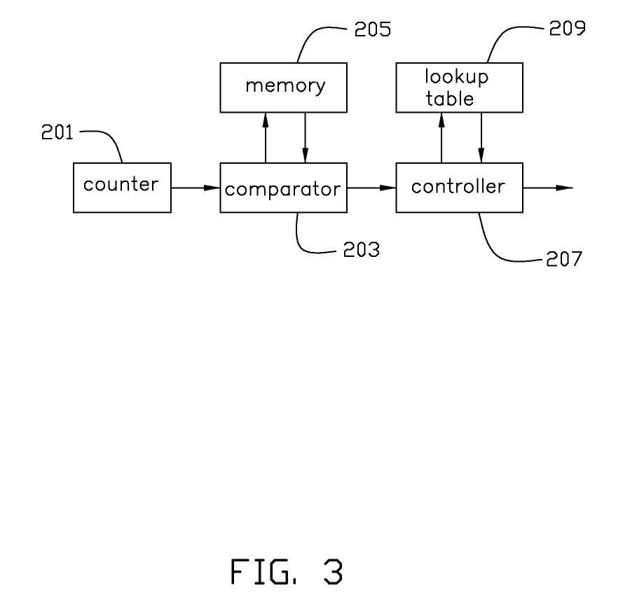

Referring to FIG. 3, an example of the gamma correction module 10 of the LCD device 1 of FIG. 1 is shown. The gamma correction module 10 includes a counter 201, a comparator 203, a memory 205, a controller 207 and a lookup table 209.

The memory 205 stores the coordinates of the abnormal pixel. The lookup table 209 stores the coordinates of the abnormal pixel, a plurality of different gray scales corresponding to the coordinates of the abnormal pixel, the first gray scale signals corresponding to the different gray scales, and the second gray scale signals corresponding to the different gray scales. The first and the second gray scale signals corresponding to the same gray scale belong to one-to-one correspondence.

When a first gray scale signal is provided to the gamma correction module 10, the counter 201 calculates the number of pulses of the synchronizing signals, and coordinates of the pixel corresponding to the first gray scale signal are identified. The comparator 203 compares the coordinates of the pixel corresponding to the first gray scale signal with the position coordinates of the abnormal pixel stored in the memory 205. If they are equal, the pixel is recognized as the abnormal pixel, and the controller 207 acquires the second gray scale signal corresponding to the first gray scale signal in the lookup table 209, and outputs the second gray scale signal to the signal conversion module 12. If they are not equal, the pixel is recognized as the normal pixel, and the controller 207 outputs the first gray scale signal to the signal conversion module 12 directly.

In the disclosed LCD device and the method for compensating the image thereof for the same gray scale, the brightness of the image displayed by an abnormal pixel and the brightness of the image displayed by a normal pixel are substantially identical, through regulating the first gray scale signal corresponding to the abnormal pixel by the gamma correction module 10, improving quality assurance for the LCD device.

The disclosure is not limited to above-described embodiments. For example, in other embodiments, the lookup table 209 can be embedded into the memory 205 and the connection between the memory 205 and controller 207 unchanged. The memory 205 can be separated from the gamma correction module 10, and the connection between the memory 205 and the comparator 203 unchanged.

It is to be further understood that even though numerous characteristics and advantages of the present embodiments have been set out in the foregoing description, together with details of the structures and functions of the embodiments, the disclosure is illustrative only; and that changes may be made in detail, especially in matters of shape, size and arrangement of parts within the principles of the invention to the full extent indicated by the broad general meaning of the terms in which the appended claims are expressed.

What is claimed is:

1. A liquid crystal display (LCD) device, comprising:
a gamma correction module and a liquid crystal panel, the liquid crystal panel comprising a plurality of pixels including normal pixels and abnormal pixels;
wherein a first gray scale signal corresponding to a current gray scale of a functioning pixel of the liquid crystal panel is provided to the gamma correction module, wherein when the functioning pixel is a normal pixel, the gamma correction module outputs the first gray scale signal to the normal pixel, and when the functioning pixel is an abnormal pixel, the gamma correction module regulates the first gray scale signal and outputs a corresponding second gray scale signal to the abnormal pixel, such that brightness of an image displayed by the normal pixel and the brightness of the image displayed by the abnormal pixel are substantially identical for a same gray scale.

2. The LCD device of claim 1, wherein the gamma correction module stores a relationship among coordinates of each abnormal pixel, a plurality of different gray scales corresponding to the coordinates of each abnormal pixel, the first gray scale signals corresponding to the different gray scales, and the second gray scale signals corresponding to the different gray scales.

3. The LCD device of claim 2, wherein the gamma correction module determines whether coordinates of the functioning pixel corresponding to the first gray scale signal in the current gray scale are substantially identical with the coordinates of any one of the abnormal pixels.

4. The LCD device of claim 3, wherein when the coordinates of the functioning pixel corresponding to the first gray scale signal in the current gray scale are substantially identical with the coordinates of one of the abnormal pixels, the functioning pixel is recognized as an abnormal pixel, and when the coordinates of the functioning pixel corresponding to the first gray scale signal in the current gray scale are different with the coordinates of each the abnormal pixel, the functioning pixel is recognized as a normal pixel.

5. The LCD device of claim 4, wherein the gamma correction module comprises a memory storing the coordinates of the abnormal pixels.

6. The LCD device of claim 5, wherein the gamma correction module comprises a lookup table storing the relationship among the coordinates of each abnormal pixel, a plurality of the different gray scales corresponding to the coordinates of each abnormal pixel, the first gray scale signals corresponding to the different gray scales, and the second gray scale signals corresponding to the different gray scales.

7. The LCD device of claim 6, wherein the gamma correction module comprises a controller, the controller to acquire the second gray scale signals corresponding to the first gray scale signal in the lookup table.

8. The LCD device of claim 7, wherein the gamma correction module further comprises a counter, and an outer signal generator, wherein the outer signal generator provides a first axis synchronizing signal and a second axis synchronizing signal of the first gray scale signal to the gamma correction module, and wherein the synchronizing signals are pulse wave signals, and the coordinates of the functioning pixel are identified through calculating the number of pulses of the synchronizing signals by the counter.

9. The LCD device of claim 8, wherein the gamma correction module further comprises a comparator, the comparator compares the coordinates of the functioning pixel corresponding to the first gray scale signal in the current gray scale with the coordinates of the abnormal pixels.

10. The LCD device of claim 9, wherein when the position coordinates of the functioning pixel are substantially identical with the coordinates of one of the abnormal pixels, the functioning pixel is recognized as an abnormal pixel, and the controller looks up the second gray scale signal corresponding to the first gray scale signal in the lookup table and outputs the second gray scale signal, and when the coordinates of the functioning pixel corresponding to the first gray scale signal in the current gray scale are different with the coordinates of each abnormal pixel, the functioning pixel is recognized as a normal pixel, and the controller outputs the first gray scale signal.

11. The LCD device of claim 10, wherein before the LCD device normally works, the coordinates of the abnormal pixels are measured using an optical apparatus and stored in the memory.

12. The LCD device of claim 11, wherein before the LCD device normally works, a plurality of second gray scale signals driving the abnormal pixels are tested when the different gray scales are displayed, and stored in the lookup table.

13. The LCD device of claim 12, further comprising a signal conversion module and a data driver, wherein when the signal conversion module receives the first gray scale signal from the gamma correction module, the signal conversion module converts the first gray scale signal and outputs a corresponding reduced swing differential signal to the data driver, and when the signal conversion module receives the second gray scale signal from the gamma correction module, the signal conversion module converts the second gray scale signal and outputs another corresponding reduced swing differential signal to the data driver.

14. A method for compensating an image of an LCD device comprising a gamma correction module and a liquid crystal panel, the liquid crystal panel comprising a plurality of pixels including abnormal pixels and normal pixels, the gamma correction module stores coordinates of the abnormal pixels, the method comprising:
providing a first gray scale signal corresponding to a current gray scale of a functioning pixel of the liquid crystal panel to the gamma correction module, and acquiring coordinates of the functioning pixel corresponding to the first gray scale signal;
comparing the coordinates of the functioning pixel with the coordinates of the abnormal pixels;
wherein when the coordinates of the functioning pixel are substantially identical with the coordinates of one of the abnormal pixels, the functioning pixel is recognized as an abnormal pixel, and gamma correction module regulates the first gray scale signal and acquiring a corresponding second gray scale signal to drive the abnormal pixel, and when the coordinates of the functioning pixel are different with the coordinates of each the abnormal pixel, the functioning pixel is recognized as a normal pixel, and gamma correction module outputs the first gray scale signal to drive the normal pixel, in order that the brightness of an image displayed by the abnormal pixels driven by the second gray scale is substantially identical with the brightness of the image displayed by the normal pixels driven by the first gray scale for a same gray scale.

15. The method of claim 14, wherein the gamma correction module comprises a lookup table, and before the step of providing the first gray scale signal corresponding to the current gray scale to the gamma correction module, a relationship among the coordinates of each abnormal pixel, a plurality of different gray scales corresponding to the coordinates of each abnormal pixel, the first gray scale signals corresponding to the different gray scales, and the second gray scale signals corresponding to the different gray scales is stored in the lookup table.

16. The method of claim 15, wherein the gamma correction module further comprises a memory, the coordinates of the abnormal pixels are measured by an external optical apparatus and stored in the memory.

17. The method of claim 16, the step of providing the first gray scale signal corresponding to the current gray scale of a functioning pixel to the gamma correction module further comprising a step for providing a first axis synchronizing signal and a second axis synchronizing signal of the first gray scale signal to the gamma correction module, wherein the first axis synchronizing signal and the second axis synchronizing signal are pulse wave signals, and the coordinates of the functioning pixel are identified through calculating the number of pulses of the synchronizing signals.

18. The method of claim 17, wherein the gamma correction module further comprises a counter, the coordinates of the functioning pixel are identified through calculating the number of pulses of the synchronizing signals by the counter.

19. The method of claim 18, wherein the gamma correction module further comprises a comparator, the coordinates of the functioning pixel corresponding to the first gray scale signal with the coordinates of each abnormal pixel are compared by the comparator.

20. The method of claim 19, wherein the gamma correction module further comprises a controller, the second gray scale signal corresponding to the first gray scale signal in the lookup table is acquired and outputted by the controller.
